(19) United States
(12) Patent Application Publication
(10) Pub. No.: US 2026/0074787 A1
(43) Pub. Date: Mar. 12, 2026

(54) EYE PATTERN EVALUATION DEVICE

(71) Applicant: Kioxia Corporation, Tokyo (JP)

(72) Inventor: Yuya MAEDA, Yokohama (JP)

(73) Assignee: Kioxia Corporation, Tokyo (JP)

(21) Appl. No.: 19/079,890

(22) Filed: Mar. 14, 2025

(30) Foreign Application Priority Data
Sep. 12, 2024 (JP) 2024-158514

(51) Int. Cl. H04B 10/079

(52) U.S. Cl. CPC H04B 10/07955

(57) ABSTRACT

According to some embodiments, an eye pattern evaluation device configured to communicate with a host includes a first interface circuit configured to acquire an eye pattern. The eye pattern evaluation device includes a controller configured to control the first interface circuit and a non-volatile memory. The controller determines whether a reception count number at a predetermined point included in the acquired eye pattern reaches a threshold value, and records, in the non-volatile memory, log information indicating communication quality at the predetermined point when the reception count number at the predetermined point reaches the threshold value.

### CROSS-REFERENCE TO RELATED APPLICATION

This application is based upon and claims the benefit of priority from Japanese Patent Application No. 2024-158514, filed Sep. 12, 2024, the entire contents of which are incorporated herein by reference.

### FIELD

Embodiments described herein relate generally to an eye pattern evaluation device.

### BACKGROUND

In recent years, development of high-performance memory systems such as universal flash storage (e.g., UFS) has been advancing. Such a memory system is provided with a function of monitoring an eye pattern generated based on a data waveform in order to evaluate communication quality of a received data signal and to analyze communication errors when the communication errors occur.

### DESCRIPTION OF THE DRAWINGS

FIG. 1 is a block diagram showing a configuration of a memory system according to one embodiment.

FIG. 2 is a diagram showing a circuit configuration of a host interface according to one embodiment.

FIG. 3 is a flowchart showing an operation of an eye pattern evaluation device according to one embodiment.

FIG. 4 is a sequence diagram showing the operation of the eye pattern evaluation device according to one embodiment.

FIG. 5 is a diagram showing log information recorded by the eye pattern evaluation device according to one embodiment.

FIG. 6 is a flowchart showing an operation of an eye pattern evaluation device according to one embodiment.

FIG. 7 is a diagram showing log information recorded by the eye pattern evaluation device according to one embodiment.

FIG. 8 is a flowchart showing an operation of an eye pattern evaluation device according to one embodiment.

FIG. 9 is a diagram illustrating the operation of the eye pattern evaluation device by using logs recorded by the eye pattern evaluation device according to one embodiment.

FIG. 10 is a diagram showing an example of the logs recorded by the eye pattern evaluation device according to one embodiment.

FIG. 11 is a block diagram showing a configuration of a system according to one embodiment.

### DETAILED DESCRIPTION

Embodiments provide a device that evaluates an eye pattern through autonomous control without requiring setting from a host side.

In general, according to one embodiment, there is provided an eye pattern evaluation device (also referred to herein as an “eye pattern evaluation system” and/or “system”) configured to communicate with a host, including: a first interface circuit configured to acquire an eye pattern; and a controller configured to control the first interface circuit and a non-volatile memory, in which the controller determines whether a reception count number at a predetermined point included in the acquired eye pattern reaches a threshold value, and records, in the non-volatile memory, log information indicating communication quality at the predetermined point when the reception count number at the predetermined point reaches the threshold value.

Hereinafter, the eye pattern evaluation device according to the embodiment will be specifically described with reference to the drawings. In the following description, identical reference numerals are assigned to elements having substantially the same functions and configurations, and duplicate descriptions may be omitted. Each embodiment to be described below exemplifies a device and a method for embodying the technical concepts of this embodiment. The technical concepts of the embodiment are not limited to the material, the shape, the structure, the disposition, and the like of the elements. The technical concepts of the embodiment may include various changes with respect to the claims.

The “eye pattern” is a graph that displays the transitions of a signal waveform of communication data, in which a large number of these transitions are sampled and overlaid. The graph in which a large number of waveforms are overlaid is called an eye pattern because the graph resembles the shape of an eye. For example, when a signal waveform transitioning from Low level→High level→Low level is overlaid with a signal waveform transitioning from High level→Low level→High level, an eye pattern with a widely open eye (in other words, a high opening rate) is obtained when the transitions to the voltage set at the same timing occur sharply. Meanwhile, in this case, when the timing of the transition is delayed, the set voltage is not reached, or the transition speed is slow, the opening rate in the eye pattern decreases. Therefore, it is possible to evaluate the communication quality of the data and analyze communication errors when the communication errors occur, based on the size and shape of the eye in the eye pattern. The “eye pattern evaluation” is an evaluation of checking the opening of the eye pattern by comparing values acquired by a deserializer 117 and a deserializer 118, which will be described below.

### 1. First Embodiment

A memory system 1 according to a first embodiment will be described. The memory system 1 according to the first embodiment is a system in which a memory controller 10 autonomously controls an operation of the memory system 1 to enable an eye pattern evaluation, without receiving a command from a host 2.

### 1-1. Overall Configuration of Memory System

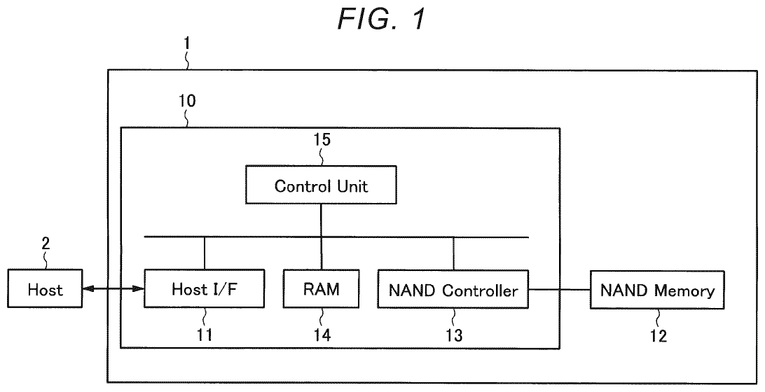

FIG. 1 is a diagram showing an example of a configuration of the memory system according to the embodiment. The memory system 1 is configured to be connected to the host 2. The memory system 1 executes data communication with the host 2 in response to a request from the host 2 while being connected to the host 2. The memory system 1 includes processing circuitry, memory, and interface components configured to execute operations associated with data communication, storage management, and/or eye pattern evaluation. It should be understood the memory system 1 may be implemented using one or more processors, control circuits, memory devices, and/or logic circuits configured to execute instructions stored in a non-transitory storage medium. The memory system 1 may include volatile or non-volatile memory, such as dynamic random-access memory (DRAM), static random-access memory (SRAM), flash memory, or phase-change memory, for temporary or persistent data storage. The processing circuitry may execute firmware or software routines to manage data transfers, error correction, logging, and signal analysis associated with eye pattern evaluation. The interface components may include physical and logical communication interfaces supporting serial, parallel, wired, and/or wireless data transfer protocols. The system may also include auxiliary circuits, such as clock generation circuits, power management circuits, and signal processing circuits, to facilitate operation across different configurations.

The host 2 is, for example, an electronic device such as a personal computer, a portable information device, or a server. The host 2 may be a processor provided in an electronic device or a circuit having a function of communicating with the memory system 1. Any interface standard can be employed as the communication interface standard between the memory system 1 and the host 2. Two or more hosts 2 may be connected to the memory system 1. The host 2 and the memory system 1 may be connected via a network. Generally, the host 2 includes processing circuitry, memory, and communication interfaces configured to manage data exchanges with the memory system 1, execute operations based on received data, and issue commands related to memory access and performance evaluation. The host 2 may be implemented using one or more processors, control circuits, memory devices, and logic circuits executing software or firmware instructions stored in a non-transitory storage medium. The host 2 may include volatile or non-volatile memory, such as DRAM, SRAM, flash memory, and/or other storage technologies, to temporarily or persistently store system data, application data, or log information received from the memory system 1. The processing circuitry may execute control routines, operating system functions, and/or application-specific instructions to process and analyze received data, manage resource allocation, and facilitate communication with the memory system 1. The communication interface may support wired or wireless protocols, including serial, parallel, and/or network-based standards, to exchange data with the memory system 1.

The memory system 1 includes the memory controller 10 and a NAND flash memory (hereinafter, referred to as a NAND memory) 12. The memory system 1 is, for example, a storage device such as a UFS device or a solid state drive (e.g., SSD). For example, when the memory system 1 is a UFS device, the host 2 is a UFS host. The NAND memory 12 is a non-volatile storage medium that functions as a storage. The NAND memory 12 is configured with one or more chips. The memory controller 10 includes a host interface 11 (also referred to as a host I/F), a NAND controller 13, a random access memory 14 (e.g., a RAM), and a control system 15.

The control system 15 includes, for example, one or more processors and/or one or more memories. The control system 15 executes various functions of the memory system 1 by executing firmware stored in the memory system 1 in advance. The storage location of the program is freely designed. For example, the firmware is stored in advance in the NAND memory 12 and is loaded into the RAM 14 at startup. The control system 15 is configured to control the host interface 11, the NAND controller 13, and the RAM 14 by executing the firmware loaded into the RAM 14. That is, the memory system 1 includes a processor (more specifically, the control system 15) and a memory (more specifically, the NAND memory 12), and the processor is configured to execute various functions by executing programs read from the memory. The memory system 1 is controlled by a plurality of processing operations based on, for example, firmware. Some or all of the plurality of processing operations executed by the control system 15 may be implemented by a hardware circuit. In addition, the control system 15 may be configured as a control circuit that is a hardware circuit.

The control system 15 controls enabling or disabling of an eye pattern acquisition function (hereinafter, referred to as an “eye monitor function”) of the host interface 11, which will be described below. Additionally, the control system 15 sets parameters such as a voltage offset and a timing offset, which will be described below, to acquire an eye pattern in the eye pattern evaluation. The details will be described below, but the control system 15 determines whether a reception count number at a predetermined point (e.g., any data point, measurement location, or signal characteristic representation within the acquired eye pattern that can be used to evaluate communication quality, error rates, signal integrity, waveform stability, and/or other operational characteristics) included in the eye pattern (for example, a point identified by a combination (e.g., any association, mapping, correlation, pairing, or structured relationship between two or more parameters, such as voltage offset and timing offset, that define a measurement location, reference point, sampling position, or evaluation criteria for signal analysis, error detection, synchronization assessment, or any other relevant function) of the voltage offset and the timing offset) reaches a threshold value. When the reception count number reaches the threshold value, the control system 15 records, in the NAND memory 12, log information indicating the communication quality (e.g., any data, metrics, or indicators reflecting signal integrity, error rates, bit error rates, waveform stability, signal distortion, noise levels, voltage variations, timing accuracy, synchronization deviations, phase shifts, transmission reliability, and/or any other parameters used to assess the performance, stability, and/or consistency of the communication channel) at the predetermined point.

The control system 15 performs the eye pattern evaluation by making the above-described determination and recording the log information for each point included in the eye pattern. The recording of the log information means recording information related to an error count number or the presence or absence of an error occurrence at a point at which the above-described determination is made, in association with information for specifying the point. That is, the communication quality is a concept including information related to the error count number or the presence or absence of an error occurrence.

The host interface 11 is an interface device for the memory system 1 to communicate with the host 2. The host interface 11 executes transfer of user data between the host 2 and the RAM 14 under the control of the control system 15. The host interface 11 is configured to acquire an eye pattern on a two-axis coordinate system using values of the voltage offset and the timing offset by sequentially updating the combination of these offsets.

When a standby request command for placing the memory system 1 into a standby state or a transfer speed change command to update a data transfer speed in the memory system 1 to a predetermined speed (e.g., either a predefined speed value or a speed that does not exceed the predefined value—predefined speed or a speed that does not exceed the predefined speed) is issued from the host 2 to the memory system 1, the host interface 11 notifies the control system 15 of these commands. Here, placing the memory system 1 into the standby state means stopping or restricting an operation of at least a part of the NAND controller 13, the RAM 14, and the control system 15 of the memory system 1. The standby request command and the transfer speed change command described above may be referred to as a “specific command”. In the present embodiment, the standby request command and the transfer speed change command are exemplified as the specific commands, but the present disclosure is not limited to these commands. For example, a command for requesting processing of clearing the reception count number or the error count number in the eye monitor function is included in the specific command.

The control system 15 records, when the host interface 11 receives the specific command from the host 2 while the eye pattern is being acquired as described above (e.g., during acquisition of the eye pattern), the following log information before the eye monitor function stops. The control system 15 determines, when the specific command is received, whether the reception count number at the above-described predetermined point reaches the threshold value. As a result of this determination, when the reception count number reaches the threshold value, the control system 15 records the log information in the NAND memory 12, and subsequently, the host interface 11 changes an operation mode based on the specific command (more specifically, control to enter the standby state based on the standby request command or control to enter the transfer speed change state based on the transfer speed change command—a transfer speed change command to update a data transfer speed of the controller to a predefined speed or a speed that does not exceed the predefined speed).

On the other hand, as a result of the above-described determination, when the reception count number does not reach the threshold value, the control system 15 notifies the host interface 11 of the result, and subsequently, the host interface 11 changes the operation mode based on the specific command. After that, when the operation mode returns from the standby state or the transfer speed change state, the host interface 11 resumes acquisition of the eye pattern.

The control system 15 sets, after recording the log information at the predetermined point in the NAND memory 12, the voltage offset and the timing offset for specifying a point (e.g., a next point) at which the evaluation of the communication quality is to be performed next after the predetermined point. Next, the control system 15 determines whether the reception count number at the next point reaches the threshold value. When the reception count number reaches the threshold value, the control system 15 records the log information indicating the communication quality at the next point in the NAND memory 12.

The details will be described below, but in the present embodiment, the above-described next point is a point (e.g., an adjacent point) adjacent to the predetermined point at which the evaluation was performed previously. That is, the adjacent point is a point identified by updating any one of the values of the voltage offset and the timing offset by one at the predetermined point. However, the next point is not limited to the adjacent point. That is, the next point may be a point that is not adjacent to the point at which the evaluation is performed.

The NAND controller 13 is an interface device for accessing the NAND memory 12. The NAND controller 13 executes transfer of user data or management information between the RAM 14 and the NAND memory 12 under the control of the control system 15. Although details are omitted, the NAND controller 13 can perform processing such as error correction.

The RAM 14 is a storage medium for temporarily storing data. The RAM 14 may be incorporated into the memory controller 10 or may be mounted outside the memory controller 10. As the RAM 14, for example, a storage medium capable of data communication at a higher speed than the NAND memory 12 can be employed. As the RAM 14, for example, a volatile or non-volatile storage medium can be employed. As the RAM 14, for example, a dynamic RAM (also referred to as a DRAM), a static RAM (also referred to as an SRAM), a ferroelectric RAM (also referred to as an FeRAM), a magnetoresistive RAM (also referred to as an MRAM), a phase change RAM (also referred to as a PRAM), or the like can be employed.

### 1-2. Circuit Configuration of Host Interface

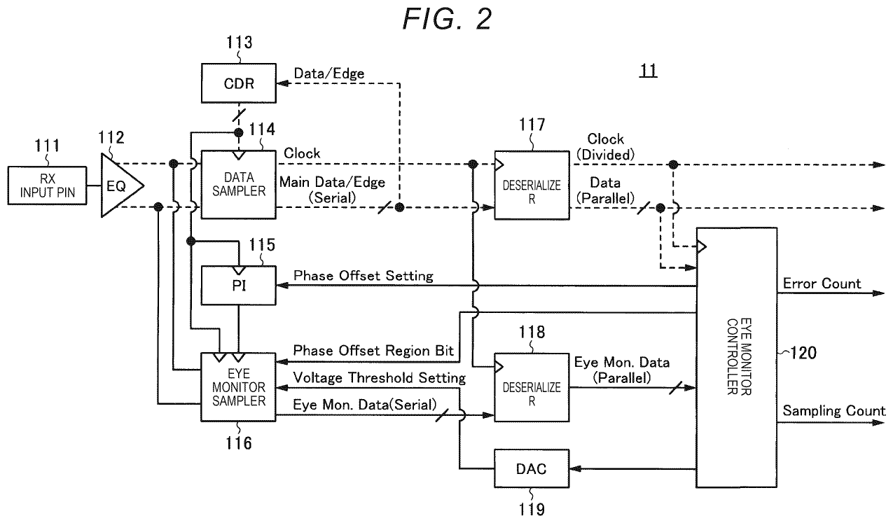

FIG. 2 is a diagram showing a circuit configuration provided in the host interface 11 according to the first embodiment. An RX input pin 111 receives a reception signal. The reception signal is, for example, a signal that differentially operates between two lines in a physical layer of a serial interface. The reception signal is sent to a data sampler 114 and an eye monitor sampler 116 after being compensated, such as by amplifying a high-frequency component through an equalizer (e.g., an EQ) 112.

The data sampler 114 extracts binary data included in the reception signal based on a reference voltage in synchronization with the clock from a clock data recovery (e.g., CDR) circuit 113 and outputs the binary data to the deserializer 117 and the CDR circuit 113 (e.g., Main Data/Edge (Serial)). The process of the data sampler 114 extracting the binary data from the reception signal will be hereinafter referred to as “sampling” or “acquisition”.

The CDR circuit 113 separates the clock from the received data (e.g., Data/Edge) and outputs the separated clock to the data sampler 114, the eye monitor sampler 116, and a PI circuit 115. The CDR circuit 113 regenerates a multi-phase clock. The multi-phase clock regenerated by the CDR circuit 113 includes a plurality of clocks having different phases.

The PI circuit 115 generates a clock timing signal with a phase change using the clock from the CDR circuit 113 as a reference and supplies the generated clock timing signal to the eye monitor sampler 116. In addition, the PI circuit 115 receives, from an eye monitor controller 120, a control signal indicating a timing within a sampling period for a signal as a sampling target. The PI circuit 115 supplies the clock timing signal generated in accordance with the control signal to the eye monitor sampler 116.

The eye monitor sampler 116 is a sample circuit that samples a signal waveform including an opening portion of the eye pattern in the reception signal. The eye monitor sampler 116 is provided in parallel with the data sampler 114. The eye monitor sampler 116 receives the reception signal processed by the EQ 112. The eye monitor sampler 116 receives the clock timing signal from the PI circuit 115 and the clock from the CDR circuit 113. The eye monitor sampler 116 determines, for the reception signal processed by the EQ 112, a voltage amplitude level of the reception signal using a reference voltage (e.g., Voltage Threshold Setting) from a DAC 119 in synchronization with the clock timing signal from the PI circuit 115 and extracts the determination result as binary data in synchronization with the clock from the CDR circuit 113. The eye monitor sampler 116 outputs the extracted reception signal (e.g., Eye Mon. Data (Serial)) to the deserializer 118.

The deserializer 117 converts the reception signal input to the deserializer 117 into parallel data and outputs the parallel data (e.g., Data (Parallel)). The deserializer 118 converts the reception signal input to the deserializer 118 into parallel data and outputs the parallel data (e.g., Eye Mon. Data (Parallel)). The DAC 119 receives a control signal indicating a reference voltage from the eye monitor controller 120 and outputs the reference voltage corresponding to the control signal to the eye monitor sampler 116.

The eye monitor controller 120 is an example of a control circuit and an output circuit. The eye monitor controller 120 sets a phase and a voltage when the signal to be processed is sampled by the eye monitor sampler 116, and outputs a control signal indicating the set content. The eye monitor controller 120 generates eye monitor data (e.g., eye pattern data) of the entire signal including the eye pattern opening of the reception signal, based on the data output by the data sampler 114 and the data output by the eye monitor sampler 116. The eye monitor controller 120 generates eye pattern data, which is data in which a large number of pieces of waveform data are overlaid on a coordinate plane where the voltage is plotted as a vertical axis and a phase (e.g., timing) is plotted as a horizontal axis. The eye monitor controller 120 outputs a control signal (e.g., Phase Offset Setting) indicating a phase or a voltage for the signal as an extraction target to the PI circuit 115 or the DAC 119 in order to generate the eye pattern data. Additionally, the eye monitor controller 120 outputs, to the eye monitor sampler 116, a signal (e.g., Phase Offset Region Bit) indicating a setting range based on a phase control signal for the signal as the extraction target.

The control signal output from the eye monitor controller 120 to the PI circuit 115 is a signal indicating a timing within the sampling period for the signal as the sampling target. The value of the timing offset for the sampling target is determined by this signal. The control signal output from the eye monitor controller 120 to the DAC 119 is a threshold value of the reference voltage and is a voltage value corresponding to the signal as the sampling target. The value of the voltage offset for the sampling target is determined by this signal. The values of the timing offset and the voltage offset are set by the control system 15 or the eye monitor controller 120. By performing sampling while sequentially updating the values of these offsets, the eye pattern can be generated.

The data sampler 114 and the eye monitor sampler 116 perform sampling based on a plurality of clocks respectively input thereto. The eye monitor controller 120 counts the number of errors (e.g., Error Count), which occur as a result of comparing the signal acquired from the data sampler 114 with the signal acquired from the eye monitor sampler 116, as well as the number of sampling operations (e.g., Sampling Count). The occurrence of the error in the comparison result indicates that the compared results do not match. The eye monitor controller 120 calculates a bit error rate (e.g., BER) based on the error count and the sampling count. This BER is represented by a value obtained by dividing the number of bits in which an error occurs by the total number of bits transmitted.

### 1-3. Operation of Memory System

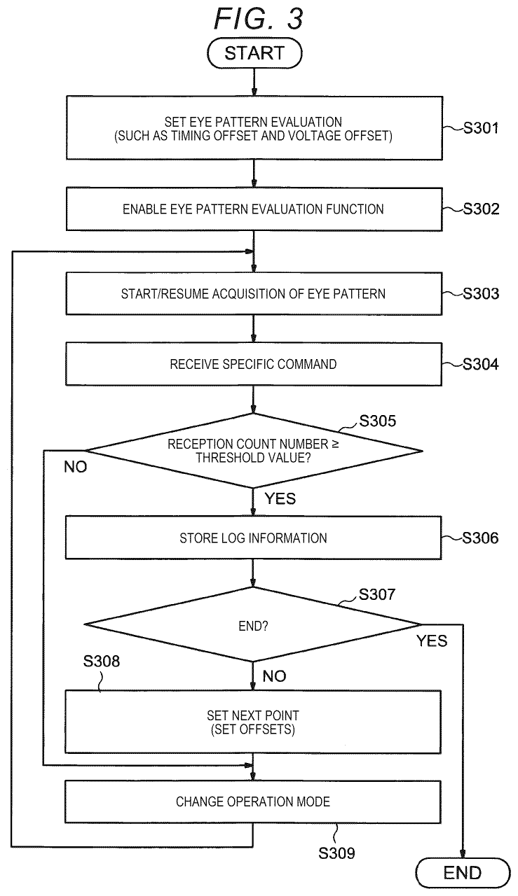

The operation of the memory system 1 will be described with reference to FIG. 3. FIG. 3 is a flowchart showing the operation of the memory system according to one embodiment. The flowchart shown in FIG. 3 is implemented through the collaboration of the host interface 11 (also referred to herein as “first interface circuit”) and the control system 15. The flowchart shown in FIG. 3 shows an operation when the specific command is issued during acquisition of the eye pattern.

As shown in FIG. 3, when the operation of the memory system 1 is started, first, the control system 15 sets the eye pattern evaluation. Specifically, when power is supplied from the host 2 and a BOOT process is performed, the memory system 1 rewrites a register or an attribute such that the firmware installed on the control system 15 sets the eye monitor function to be enabled, and the control system 15 sets the voltage offset and the timing offset (e.g., step S301) and specifies a predetermined point at which the reception count number is to be determined. Next, the control system 15 enables the eye monitor function of the host interface 11 (e.g., step S302).

When the eye monitor function is enabled, the host interface 11 starts the acquisition of the eye pattern (e.g., step S303). In S303, for example, the acquisition of the eye pattern may be started when the transfer speed satisfies a predetermined condition. For example, the acquisition of the eye pattern may be started when the transfer speed enters an “HS-GEAR5 mode” in the “MIPI M-PHY v5.0” standard. In the setting of the eye pattern in S301, a transfer speed at which the acquisition of the eye pattern is started may be set. When the acquisition of the eye pattern is started, the host interface 11 performs the acquisition of the eye pattern while receiving a write/read request from the host 2 and operations during the writing/reading of the attribute or filler symbol transmission.

When the host interface 11 receives the specific command from the host 2 during the acquisition of the eye pattern (e.g., step S304), the control system 15 determines whether the reception count number reaches the threshold value for a setting point (e.g., a predetermined point included in the eye pattern) identified by the currently set voltage offset and timing offset (e.g., step S305).

In S305, when the control system 15 determines that the reception count number reaches the threshold value (e.g., “YES” in S305), the control system 15 records the log information at the above-described setting point in the NAND memory 12 (e.g., step S306). As described above, the log information is, for example, information related to the error count number or the presence or absence of error occurrence at the setting point. On the other hand, in S305, when the control system 15 determines that the reception count number does not reach the threshold value (e.g., “NO” in S305), the control system 15 notifies the host interface 11 of the result, and the host interface 11 changes the operation mode based on the specific command (e.g., step S309).

In S306, when the log information is recorded, the control system 15 determines whether the acquisition operation of the eye pattern ends (e.g., step S307). In S307, when the control system 15 determines that the acquisition operation of the eye pattern ends (e.g., “YES” in S307), the control system 15 ends the flow in FIG. 3. On the other hand, in S307, when the control system 15 determines that the acquisition operation of the eye pattern does not end (e.g., “NO” in S307), the control system 15 sets the next point at which the evaluation of the communication quality is to be performed next after the current setting point (e.g., step S308). For example, the control system 15 increments or decrements the voltage offset or the timing offset such that an adjacent point (e.g., any point within a predefined or dynamically determined range of the current setting point, where the range may be based on a fixed step size, a relative measurement threshold, a function of prior signal characteristics, and/or any other criteria defining proximity in a multi-dimensional parameter space, such as voltage-time coordinates, frequency-phase domains, and/or other signal evaluation frameworks) adjacent to the current setting point is specified.

Then, the host interface 11 changes the operation mode based on the specific command (e.g., step S309). For example, the host interface 11 controls the memory system 1 to enter the standby state based on the standby request command. After that, when the memory system 1 returns from the standby state, the host interface 11 resumes the acquisition operation of the eye pattern (e.g., S303).

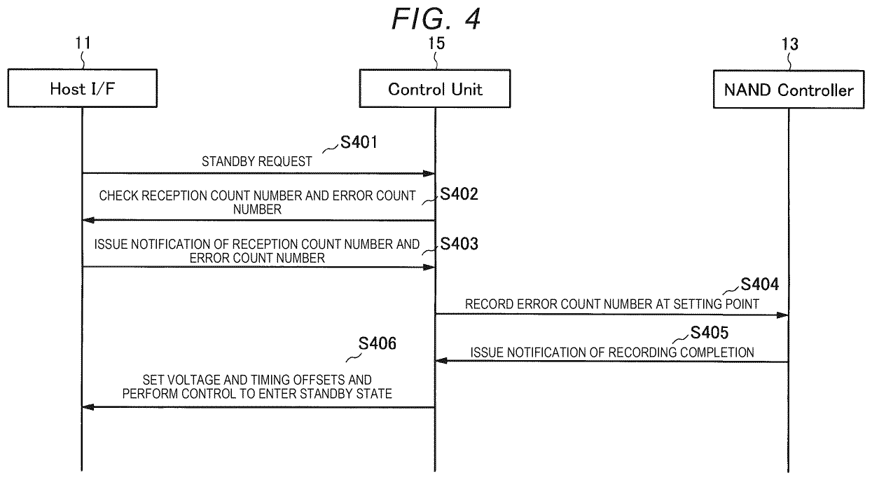

A flow of processing between the host interface 11, the NAND controller 13, and the control system 15 will be described with reference to FIG. 4. FIG. 4 is a sequence diagram showing the operation of the eye pattern evaluation device according to one embodiment. FIG. 4 shows an example in which the standby request command is issued as the specific command from the host 2, and the error count number is recorded as the log information indicating the communication quality.

When the standby request command is issued from the host 2 to the memory system 1, as shown in FIG. 4, the host interface 11 notifies the control system 15 of a standby request (e.g., step S401). In response to the standby request, the control system 15 notifies the host interface 11 of a request to check the reception count number and to check the error count number (e.g., step S402). In response to the check request, the host interface 11 issues notification of the reception count number and the error count number (e.g., step S403). In response to the above-described single check request, the host interface 11 may issue notification of the reception count number and the error count number at once, or the host interface 11 may first issue notification of only the reception count number and then issue notification of the error count number only when the reception count number reaches the threshold value.

The control system 15 instructs the NAND controller 13 to record the error count number received from the host interface 11 in the NAND memory 12 as the log information in association with information for specifying the currently set setting point (for example, the voltage offset and the timing offset) (e.g., step S404). When the NAND controller 13 completes the recording of the log information in the NAND memory 12, the NAND controller 13 notifies the control system 15 that the recording of the log information is completed (e.g., step S405). Then, the control system 15 sets the voltage offset and the timing offset corresponding to the next point, and the host interface 11 controls the memory system 1 to enter the standby state (e.g., step S406).

### 1-4. Log Information

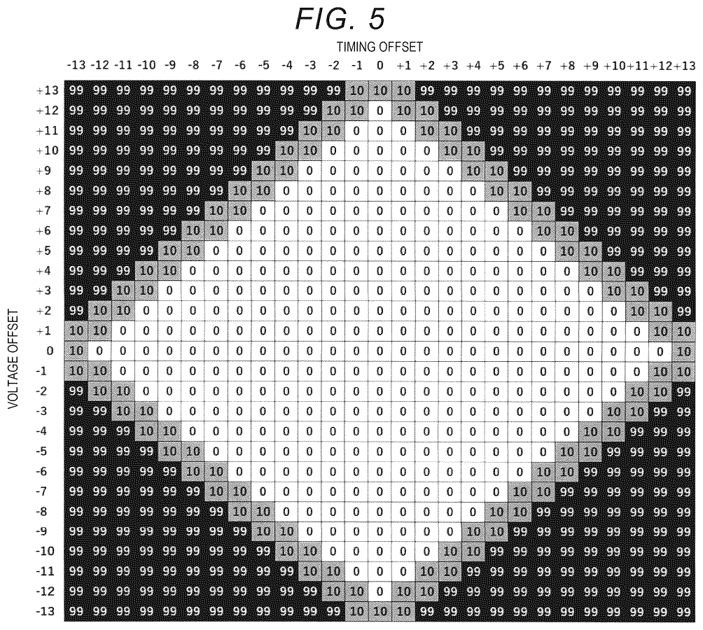

FIG. 5 shows a diagram visualizing the log information recorded in the NAND memory 12. In FIG. 5, the horizontal axis indicates the value of the timing offset, and the vertical axis indicates the value of the voltage offset. In FIG. 5, integers of “−13” to “+13” are displayed as the values of the timing offset and the values of the voltage offset, respectively. FIG. 5 shows that a cell corresponding to each combination of the timing offset and the voltage offset is provided, with each cell displaying the error count number. As shown in FIG. 5, when the error count number is “0”, the cell is displayed in white. When the error count number is “10”, the cell is displayed in gray. When the error count number is “99”, the cell is displayed in black.

In FIG. 5, the maximum value of the error count number is “99”, but the maximum value may be 100 or greater. In addition, for the sake of convenience, colors are applied to the cells, but coloring the cells is not essential.

In FIG. 5, since a region where the error count number is “0” is a region where the signal acquired from the data sampler 114 and the signal acquired from the eye monitor sampler 116 in FIG. 2 match each other, this region corresponds to the eye portion of the eye pattern displayed as a graph. That is, in the log information shown in FIG. 5, the communication quality of data can be evaluated based on the area or the shape of the region where the error count number is “0” or the region where the error count number is relatively small (for example, the region where the error count number is “3”or less).

For example, when a command for reading the above-described log information is installed on the host 2, the control system 15 reads the log information recorded in the NAND memory 12 based on a command for requesting the log information and notifies the host 2 of the log information via the host interface 11.

In a memory system in the related art, in a case where the eye monitor function is enabled, the setting is required to be performed on the host. Therefore, in a case where a program for enabling the eye monitor function of the memory system is not installed on the host, the signal waveform and the eye pattern in the circuit cannot be checked on the memory system. Further, in order to reduce power consumption of the memory system, in a case where the specific command as described above is input and the reception count number required to calculate the BER is not obtained at the time of the input, the reception count number and the error count number obtained up to that point are cleared. Therefore, when it is necessary to perform the setting on the host 2, it is difficult to perform the evaluation using the eye monitor function.

Meanwhile, even in such a case, the memory system 1 according to the present embodiment can avoid such a problem. Specifically, even when the specific command is issued from the host 2 on which a program for enabling the eye monitor function of the memory system 1 is not installed, the log information is recorded in the NAND memory 12 through the functions of the host interface 11 and the control system 15. Therefore, even when the reception count number and the error count number are cleared when there is a change in the operation mode based on the specific command, the reception count number and the error count number obtained up to that point can be used. Accordingly, it is possible to evaluate the eye pattern through autonomous control without requiring settings from the host 2.

### 2. Second Embodiment

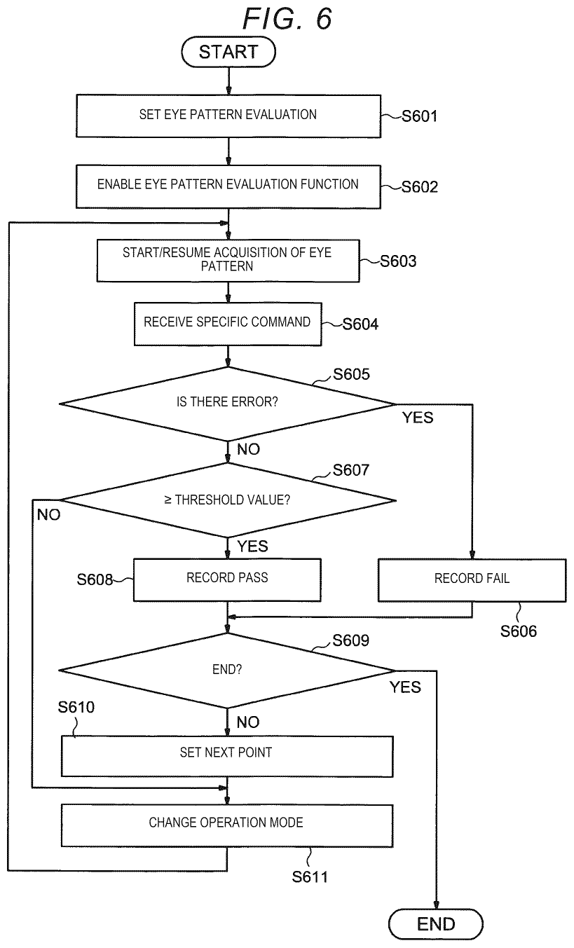

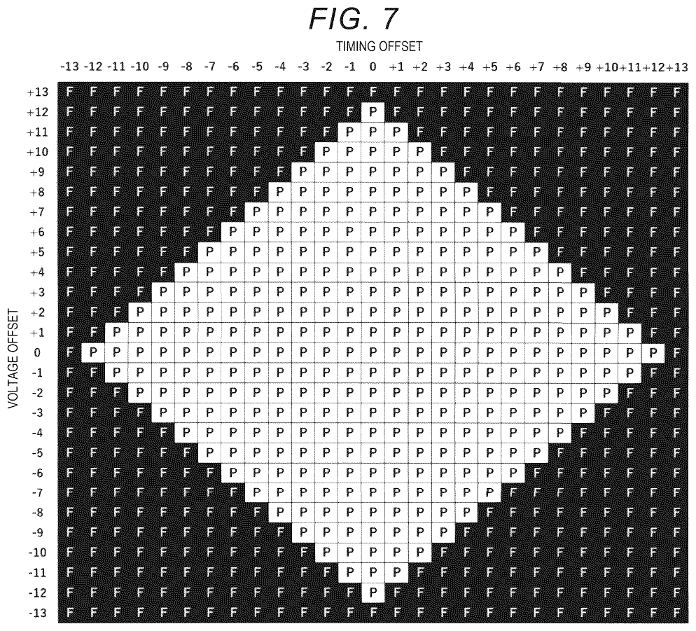

A memory system according to a second embodiment will be described with reference to FIGS. 6 and 7. The memory system 1 according to the second embodiment is similar to the memory system 1 according to the first embodiment. In the following description, the description of the same configurations as those of the memory system 1 according to the first embodiment will be omitted, and differences between the two will be mainly described. Regarding the memory system 1 according to the second embodiment, the overall configuration and the configuration of each functional unit (for example, the host interface 11 and the control system 15) of the memory system 1 are the same as those in the first embodiment.

In the first embodiment, the error count number is recorded as the log information, whereas in the second embodiment, information related to the presence or absence of error occurrence is recorded as the log information.

### 2-1. Operation of Memory System

The operation of the memory system 1 will be described with reference to FIG. 6. FIG. 6 is a flowchart showing the operation of the memory system according to one embodiment. The flowchart shown in FIG. 6 is implemented through the collaboration of the host interface 11 and the control system 15. The flowchart shown in FIG. 6 shows an operation when the specific command is issued during the acquisition of the eye pattern.

The flowchart shown in FIG. 6 is similar to the flowchart shown in FIG. 3. Since steps S601 to S604 in FIG. 6 are the same as steps S301 to S304 in FIG. 3, respectively, the description thereof will be omitted.

As shown in FIG. 6, when the host interface 11 receives the specific command from the host 2 during the acquisition of the eye pattern (e.g., step S604), the control system 15 determines the presence or absence of error occurrence for a setting point (e.g., a predetermined point included in the eye pattern) identified by the currently set voltage offset and timing offset (e.g., step S605). When the error count number is one or more at the setting point, the control system 15 determines that an error occurs at the setting point (e.g., “YES” in S605), and records “FAIL” in the NAND memory 12 as the log information at the setting point (e.g., step S606). On the other hand, when the error count number is zero at the setting point, the control system 15 determines that no error occurs at the setting point (e.g., “NO” in S605), and determines whether the reception count number at the setting point reaches the threshold value (e.g., step S607).

In S607, when the control system 15 determines that the reception count number reaches the threshold value (e.g., “YES” in S607), the control system 15 records “PASS” in the NAND memory 12 as the log information at the above-described setting point (e.g., step S608). On the other hand, in S607, when the control system 15 determines that the reception count number does not reach the threshold value (e.g., “NO” in S607), the control system 15 notifies the host interface 11 of the result, and the host interface 11 changes the operation mode based on the specific command (e.g., step S611).

In S606 or S608, when the log information is recorded, the control system 15 determines whether the acquisition operation of the eye pattern ends (e.g., step S609). In S609, when the control system 15 determines that the acquisition operation of the eye pattern ends (e.g., “YES” in S609), the control system 15 ends the flow in FIG. 6. On the other hand, in S609, when the control system 15 determines that the acquisition operation of the eye pattern does not end (e.g., “NO” in S609), the control system 15 sets the next point at which the evaluation of the communication quality is to be performed next after the current setting point (e.g., step S610). For example, the control system 15 increments or decrements the voltage offset or the timing offset such that the adjacent point adjacent to the current setting point is specified.

Then, the host interface 11 changes the operation mode based on the specific command (e.g., step S611). For example, the host interface 11 controls the memory system 1 to enter the standby state based on the standby request command. After that, when the memory system 1 returns from the standby state, the host interface 11 resumes the acquisition operation of the eye pattern (e.g., S603).

### 2-2. Log Information

A diagram visualizing the log information recorded in the NAND memory 12 will be described with reference to FIG. 7. The diagram shown in FIG. 7 is similar to the diagram shown in FIG. 5, but the information recorded in each cell is different between the diagrams. Specifically, in FIG. 7, the presence or absence of error occurrence is recorded in each cell. The “F” recorded in a cell corresponds to the log information when it is determined that an error occurs at the setting point corresponding to the cell. The “P” recorded in a cell corresponds to the log information when it is determined that no error occurs at the setting point corresponding to the cell. When an error occurs, the cell is displayed in black. When no error occurs, the cell is displayed in white.

In the log information shown in FIG. 7, the communication quality of data can be evaluated based on the area or the shape of a region where the cell record is marked as “P”.

As described above, with the memory system 1 according to the present embodiment, the log information can be simplified. Additionally, when a single error is present, the operation for the setting point that is currently being evaluated can end, and the next point can be evaluated, which is expected to further accelerate the operation.

### 3. Third Embodiment

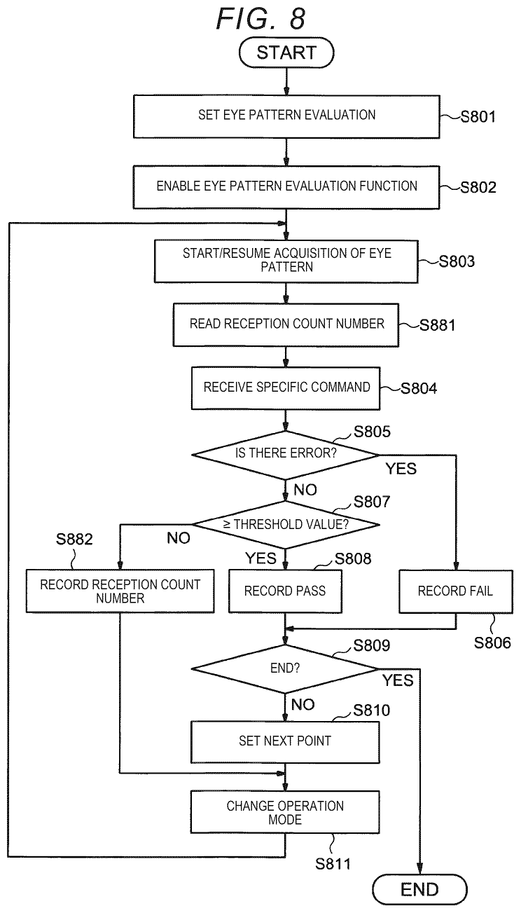

A memory system according to a third embodiment will be described with reference to FIG. 8. The memory system 1 according to the third embodiment is similar to the memory system 1 according to the second embodiment. In the following description, the description of the same configurations as those of the memory system 1 according to the second embodiment will be omitted, and differences between the two will be mainly described. Regarding the memory system 1 according to the third embodiment, the overall configuration and the configuration of each functional unit (for example, the host interface 11 and the control system 15) of the memory system 1 are the same as those in the first embodiment.

The third embodiment differs from the second embodiment in that the reception count number obtained up to that point is recorded when the reception count number does not reach the threshold value upon issuing the specific command, and the recorded count number is read upon returning from the operation mode based on the specific command.

### 3-1. Operation of Memory System

The operation of the memory system 1 will be described with reference to FIG. 8. FIG. 8 is a flowchart showing the operation of the memory system according to one embodiment. The flowchart shown in FIG. 8 is implemented through the collaboration of the host interface 11 and the control system 15. The flowchart shown in FIG. 8 shows an operation when the specific command is issued during the acquisition of the eye pattern.

The flowchart shown in FIG. 8 is similar to the flowchart shown in FIG. 6. Since steps S801 to S811 in FIG. 8 are the same as steps S601 to S611 in FIG. 6, respectively, the description thereof will be omitted.

As shown in FIG. 8, in S807, when the control system 15 determines that the reception count number does not reach the threshold value (e.g., “NO” in S807), the control system 15 records the reception count number at the current setting point in the NAND memory 12 (e.g., step S882). When the processing in S882 is completed, the control system 15 notifies the host interface 11 that the processing is completed, and the host interface 11 changes the operation mode based on the specific command (e.g., step S811). After that, when the memory system 1 returns from the operation mode based on the specific command, the host interface 11 resumes the acquisition operation of the eye pattern (e.g., S803).

When the acquisition operation of the eye pattern is resumed in S803, the control system 15 reads the reception count number recorded in the NAND memory 12 (e.g., step S881). Then, the reception count is resumed based on the read reception count number.

When the reception count number does not reach the threshold value upon issuing the specific command, the reception count number obtained up to that point is cleared. However, with the memory system 1 according to the present embodiment, in such a case, the reception count number is recorded in the NAND memory 12, and the reception count number recorded in the NAND memory 12 is read when the acquisition of the eye pattern is resumed. Therefore, even in a case where the specific command is issued in a short period of time, the reception count number until the specific command is issued can be effectively used.

### 4. Fourth Embodiment

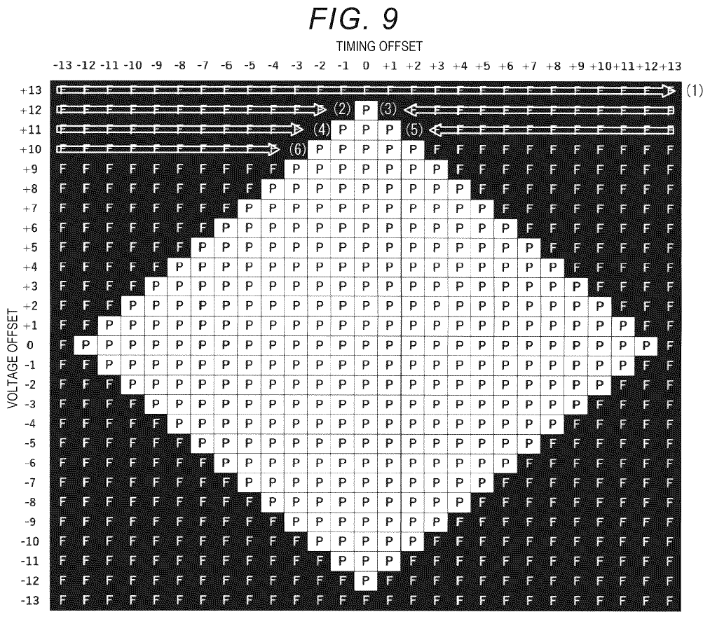

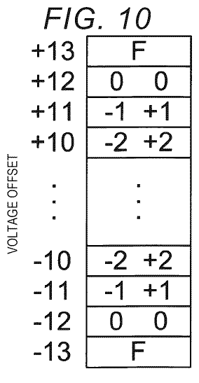

A memory system according to a fourth embodiment will be described with reference to FIGS. 9 and 10. The memory system 1 according to the fourth embodiment is similar to the memory system 1 according to the second embodiment. In the following description, the description of the same configurations as those of the memory system 1 according to the second embodiment will be omitted, and differences between the two will be mainly described. Regarding the memory system 1 according to the fourth embodiment, the overall configuration and the configuration of each functional unit (for example, the host interface 11 and the control system 15) of the memory system 1 are the same as those in the first embodiment.

In the second embodiment, the eye pattern is acquired and the log information is recorded for all the cells arranged in a matrix configuration by sequentially updating the voltage offset and the timing offset. In contrast, in the fourth embodiment, the eye pattern is acquired and the log information is recorded for only a part of the cells arranged in a matrix configuration, and for the other cells, the acquisition of the eye pattern is not performed, and the log information is determined by estimation.

### 4-1. Scanning Method of Voltage Offset and Timing Offset

A scanning method of the voltage offset and the timing offset will be described with reference to FIG. 9. In the present embodiment, when the acquisition operation of the eye pattern is started, as indicated by an arrow (1) in FIG. 9, the reception count and the error count are measured while the value of the timing offset is incremented (by +1) from [voltage offset: timing offset]=[+13: −13]. When the log information in each cell is “F”, the above-described operation is repeated, and the value of the voltage offset is decremented (by −1) when the value of the timing offset reaches [+13].

Next, as indicated by an arrow (2) in FIG. 9, the reception count and the error count are measured while the timing offset is incremented (by +1) from [voltage offset: timing offset]=[+12: −13] (that is, from the minimum value of the timing offset). Here, when the log information in a certain cell is “P” (e.g., in FIG. 9, when the timing offset is [0]), the measurement indicated by the arrow (2) is interrupted, and as indicated by an arrow (3) in FIG. 9, the reception count and the error count are measured while the timing offset is decremented (by −1) from [voltage offset: timing offset]=[+12: +13] (that is, the maximum value of the timing offset). Since only a single cell is present in which the log information is “P” when the voltage offset is [+12], in the measurement indicated by the arrow (3), the above-described measurement is performed for all the values of the timing offset until the value of the timing offset reaches [+1], and the value of the voltage offset is decremented (by −1).

Next, as indicated by an arrow (4) in FIG. 9, the reception count and the error count are measured while the timing offset is incremented (by +1) from [voltage offset: timing offset]=[+11: −13]. Here, when the log information in a certain cell is “P” (e.g., in FIG. 9, when the timing offset is [−1]), the measurement indicated by the arrow (4) is interrupted, and as indicated by an arrow (5) in FIG. 9, the reception count and the error count are measured while the timing offset is decremented (by −1) from [voltage offset: timing offset]=[+11: +13]. Here, when the log information in a certain cell is “P” (e.g., in FIG. 9, when the timing offset is [+1]), the value of the voltage offset is decremented (by −1), and as indicated by an arrow (6) in FIG. 9, the reception count and the error count are measured while the timing offset is incremented (by +1) from [voltage offset: timing offset]=[+10: −13].

The eye pattern is estimated to have “P” recorded in almost all of the cells in a region corresponding to the inner side of the contour of the eye. Therefore, when the contour portion of the eye is specified, the measurement of the reception count and the error count in the region on the inner side of the contour portion can be omitted.

In other words, in the above-described configuration, the control system 15 changes (more specifically, increments), after recording the log information “F” at a certain predetermined point (for example, [voltage offset: timing offset]=[+11: −3]) in the NAND memory 12, the value of the timing offset to set the adjacent point (for example, [voltage offset: timing offset]=[+11: −2]) adjacent to the certain predetermined point. Since an error occurs at the adjacent point [+11: −2], the control system 15 changes (more specifically, increments) the value of the timing offset to set the adjacent point (for example, [voltage offset: timing offset]=[+11: −1]) adjacent to the adjacent point [+11: −2]. On the other hand, since no error occurs at the adjacent point [+11: −1], the control system 15 changes (more specifically, decrements) the value of the voltage offset to set a point (for example, [voltage offset: timing offset]=[+10: −13]) different in the value of the voltage offset from the predetermined point [+11: −3] and the adjacent point [+11: −2].

In the above-described configuration, instead of determining the presence or absence of error occurrence, it may be determined whether the error count number reaches a threshold value. In this case, the control system 15 increments the value of the timing offset when the error count number reaches the threshold value, and the control system 15 decrements the value of the voltage offset when the error count number does not reach the threshold value.

In the above-described configuration, the timing offset and the voltage offset may be interchanged. That is, the control system 15 may measure the reception count and the error count while decrementing the voltage offset by (−1) from [voltage offset: timing offset]=[+13: −13].

FIG. 10 shows an example of the logs shown in FIG. 9. In the logs shown in FIG. 10, the value of the timing offset when “P” is recorded as the log information is recorded for each voltage offset. For example, when the timing offset is [+13], [F] is recorded as a log because “P” is not recorded. When the timing offset is [+12], whether the timing offset is incremented from [−13] or decremented from [+13], “P” is recorded as the log information when the timing offset is [0], so that “0 0” is recorded as the log information. When the timing offset is [+11], as the timing offset is incremented from [−13], “P” is recorded as the log information when the timing offset is [−1], and as the timing offset is decremented from [+13], “P” is recorded as the log information when the timing offset is [+1]. Therefore, in this case, “−1 +1” is recorded as the log information. The log shown in FIG. 10 is an example and is not limited to the format of the logs.

In the above-described example, a configuration is exemplified in which the voltage offset is decremented and the timing offset is incremented from [−13] when “P” is recorded as the log information, but the present disclosure is not limited to this configuration. For example, when “P” is recorded as the log information, the voltage offset may be decremented while the timing offset is maintained, and the timing offset may be decremented from the cell. In this case, the voltage offset may be decremented while the timing offset is maintained when the log information is changed from “P” to “F”. That is, the boundary between “P” and “F” may be specified while scanning in a stepwise manner.

As described above, with the memory system 1 according to the present embodiment, the acquisition of predictable log information can be omitted, thereby enabling further acceleration of the operation.

### 5. Fifth Embodiment

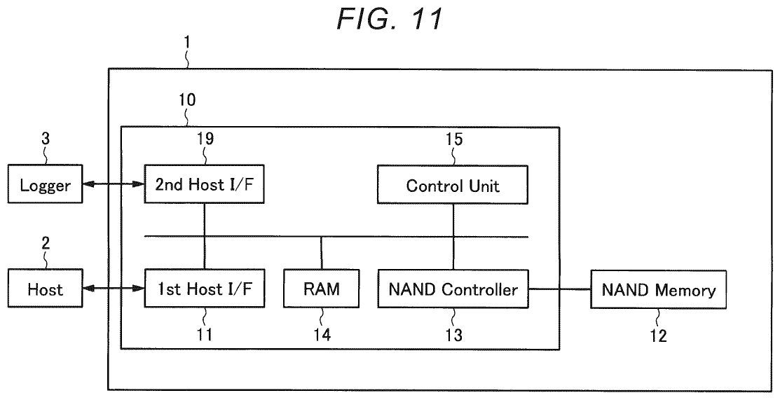

A memory system according to a fifth embodiment will be described with reference to FIG. 11. The memory system 1 according to the fifth embodiment is similar to the memory system 1 according to the first embodiment. In the following description, the description of the same configurations as those of the memory system 1 according to the first embodiment will be omitted, and the differences between the two will be mainly described.

FIG. 11 is a block diagram showing a configuration of a system according to one embodiment. The block diagram shown in FIG. 11 is similar to the block diagram shown in FIG. 1, but a second host interface 19 (also referred to herein as “second interface circuit”) that communicates with a dedicated logger 3 is provided, in addition to a first host interface 11 (also referred to herein as “first interface circuit”) corresponding to the host interface 11 in FIG. 1. The second host interface 19 is configured to acquire the log information recorded in the NAND memory 12. For example, a low-speed interface such as an SPI communication interface may be used as the second host interface 19.

As shown in FIG. 11, the memory system 1 includes the second host interface 19, so that the log information recorded in the NAND memory 12 can be read through a method other than via the host 2. Therefore, the log information can be read even when a command for reading the log information is not installed on the host 2.

Hitherto, the embodiments according to the present disclosure are described with reference to the drawings, but the present disclosure is not limited to the above-described embodiments and can be changed as appropriate within a scope that does not depart from the gist of the present disclosure. For example, based on the memory system of the present embodiment, any modifications such as the addition, deletion, or design changes of elements made by those skilled in the art are also included within the scope of the present disclosure, as long as the modifications retain the essence of the present disclosure. Further, the embodiments mentioned above can be appropriately combined as long as there is no contradiction between them, and technical matters used in common across the embodiments are included in each embodiment, unless otherwise explicitly stated.

Even when there are other operations and effects that are different from the operations and effects brought about by each of the embodiments mentioned above, those that are apparent from the description of the present specification or those that are easily predictable by those skilled in the art are obviously considered to be brought about by the present disclosure.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An eye pattern evaluation device configured to communicate with a host, comprising:
a first interface circuit configured to acquire an eye pattern; and
a controller configured to control the first interface circuit and a non-volatile memory;
wherein the controller:
determines whether a reception count number at a predetermined point in the acquired eye pattern reaches a threshold value; and
records, in the non-volatile memory, log information indicating communication quality at the predetermined point when the reception count number at the predetermined point reaches the threshold value.

2. The eye pattern evaluation device of claim 1, wherein the controller determines, when the first interface circuit receives a specific command from the host while the eye pattern is being acquired, whether the reception count number at the predetermined point in the acquired eye pattern reaches the threshold value.

3. The eye pattern evaluation device of claim 2, wherein the specific command comprises a standby request command for stopping an operation of the controller, or a transfer speed change command to update a data transfer speed of the controller to a predefined speed or a speed that does not exceed the predefined speed.

4. The eye pattern evaluation device of claim 3, wherein:
the predetermined point is identified by a single combination of a voltage offset and a timing offset set when the eye pattern is acquired; and
the controller:
sets, after recording the log information at the predetermined point in the non-volatile memory, a combination of the voltage offset and the timing offset indicating an adjacent point adjacent to the predetermined point;
determines whether a reception count number at the adjacent point reaches the threshold value; and
records, in the non-volatile memory, the log information at the adjacent point when the reception count number at the adjacent point reaches the threshold value.

5. The eye pattern evaluation device of claim 3, wherein the first interface circuit:
performs, after the log information is recorded in the non-volatile memory, control to enter a standby state based on the standby request command or a transfer speed change state based on the transfer speed change command; and
resumes acquisition of the eye pattern upon returning from the standby state or the transfer speed change state.

6. The eye pattern evaluation device of claim 1, wherein the communication quality comprises information corresponding to an error count number, or presence or absence of an error occurrence at the predetermined point.

7. The eye pattern evaluation device of claim 4 wherein the controller records, as the log information in the non-volatile memory, an error count number at a point identified by a combination of one of a plurality of the voltage offsets and one of a plurality of the timing offsets, the point comprising the predetermined point and the adjacent point.

8. The eye pattern evaluation device of claim 4, wherein the controller records, as the log information in the non-volatile memory, different information depending on whether an error occurs or no error occurs, at a point identified by a combination of one of a plurality of the voltage offsets and one of a plurality of the timing offsets, the point comprising the predetermined point and the adjacent point.

9. The eye pattern evaluation device of claim 2, wherein the controller records, upon receiving the specific command, the reception count number at the predetermined point in the non-volatile memory when the reception count number does not reach the threshold value.

10. The eye pattern evaluation device of claim 9, wherein:
the specific command comprises a standby request command for stopping an operation of the controller, or a transfer speed change command to update a data transfer speed of the controller to a predefined speed or a speed that does not exceed the predefined speed; and
the controller:
performs, after recording the reception count number in the non-volatile memory, control to enter a standby state based on the standby request command or a transfer speed change state based on the transfer speed change command;
resumes acquisition of the eye pattern upon returning from the standby state or the transfer speed change state; and
reads the reception count number recorded in the non-volatile memory.

11. The eye pattern evaluation device of claim 1, wherein:
the predetermined point is identified by a single combination of a voltage offset and a timing offset set when the eye pattern is acquired; and
the controller:
sets a combination of the voltage offset and the timing offset indicating a first adjacent point adjacent to the predetermined point by updating a value of the timing offset after recording the log information at the predetermined point in the non-volatile memory;
determines whether an error count number at the first adjacent point reaches a threshold value or an error occurs;
sets a combination of the voltage offset and the timing offset indicating a second adjacent point adjacent to the first adjacent point by updating the value of the timing offset when the error count number at the first adjacent point reaches the threshold value or an error occurs; and
sets a combination of the voltage offset and the timing offset indicating a third point different in a value of the voltage offset from the predetermined point and the first adjacent point by updating the value of the voltage offset when the error count number at the first adjacent point does not reach the threshold value or no error occurs.

12. The eye pattern evaluation device of claim 1, wherein:
the predetermined point is identified by a single combination of a voltage offset and a timing offset set when the eye pattern is acquired; and
the controller:
sets a combination of the voltage offset and the timing offset indicating a first adjacent point adjacent to the predetermined point by updating a value of the voltage offset after recording the log information at the predetermined point in the non-volatile memory;
determines whether an error count number at the first adjacent point reaches a threshold value or an error occurs;
sets a combination of the voltage offset and the timing offset indicating a second adjacent point adjacent to the first adjacent point by updating the value of the voltage offset when the error count number at the first adjacent point reaches the threshold value or an error occurs; and
sets a combination of the voltage offset and the timing offset indicating a third point different in a value of the timing offset from the predetermined point and the first adjacent point by updating the value of the timing offset when the error count number at the first adjacent point does not reach the threshold value or no error occurs.

13. The eye pattern evaluation device of claim 1, further comprising:
a second interface circuit configured to acquire the log information recorded in the non-volatile memory, the second interface circuit different from the first interface circuit.

14. The eye pattern evaluation device of claim 1, wherein the controller notifies the host of the log information based on a command received from the host.

15. An system, comprising:
an interface configured to acquire an eye pattern; and
a controller configured to:
control the interface and a memory;
determine whether a reception count number at a predetermined point in the acquired eye pattern reaches a threshold value; and
record, in the memory, log information indicating communication quality at the predetermined point when the reception count number at the predetermined point reaches the threshold value.

16. The system of claim 15, wherein the controller determines, when the interface receives a specific command from a host while the eye pattern is being acquired, whether the reception count number at the predetermined point in the acquired eye pattern reaches the threshold value.

17. The system of claim 16, wherein the specific command comprises a standby request command for stopping an operation of the controller, or a transfer speed change command to update a data transfer speed of the controller to a predefined speed or a speed that does not exceed the predefined speed.

18. The system of claim 17, wherein:
the predetermined point is identified by a single combination of a voltage offset and a timing offset set when the eye pattern is acquired; and
the controller:
sets, after recording the log information at the predetermined point in the memory, a combination of the voltage offset and the timing offset indicating an adjacent point adjacent to the predetermined point;
determines whether a reception count number at the adjacent point reaches the threshold value; and
records, in the memory, the log information at the adjacent point when the reception count number at the adjacent point reaches the threshold value.

19. The system of claim 17, wherein the interface:
performs, after the log information is recorded in the memory, control to enter a standby state based on the standby request command or a transfer speed change state based on the transfer speed change command; and
resumes acquisition of the eye pattern upon returning from the standby state or the transfer speed change state.

20. The system of claim 15, wherein the communication quality comprises information corresponding to an error count number, or presence or absence of an error occurrence at the predetermined point.
